(19) United States
(12) Patent Application Publication
(10) Pub. No.: US 2013/0284670 A1
(43) Pub. Date: Oct. 31, 2013

(54) DEMERCURIZATION OF SOLUTIONS BY ULTRAFILTRATION

(71) Applicants: Michael HORN, Niederkassel (DE); Bernd Helpap, Bonn (DE); Michael Thiel, Windeck-Dattenfeld (DE); Manfred Neumann, Marl (DE)

(72) Inventors: Michael HORN, Niederkassel (DE); Bernd Helpap, Bonn (DE); Michael Thiel, Windeck-Dattenfeld (DE); Manfred Neumann, Marl (DE)

(73) Assignee: EVONIK DEGUSSA GMBH, Essen (DE)

(21) Appl. No.: 13/869,328

(22) Filed: Apr. 24, 2013

(30) Foreign Application Priority Data
Apr. 27, 2012 (DE) 10 2012 207 115.6

(51) Int. Cl. B01D 61/14

(52) U.S. Cl. CPC B01D 61/145
USPC 210/636; 210/651

(57) ABSTRACT

The present invention provides a process for removal of mercury from a solution by ultrafiltration with filtration membranes having a pore size of less than or equal to 0.25 μm, for removing mercury from mercury-containing solutions, including alkali metal hydroxide solutions or alkali metal alkoxide solutions.

### CROSS REFERENCE TO RELATED APPLICATIONS

This application claims priority to German Application No. 102012207115.6, filed Apr. 27, 2012, the disclosure of which is incorporated herein by reference in its entirety.

### BACKGROUND OF THE INVENTION

The present invention relates to the use of filtration membranes having a pore size of less than or equal to 0.25 μm, preferably less than or equal to 0.1 μm and in particular less than or equal to 0.05 μm or less than or equal to 20 000 dalton retention capability, for removing mercury from mercury-containing solutions, in particular from alkali metal hydroxide solutions or alkali metal alkoxide solutions.

Alkaline solutions which can be produced by amalgam processes (aqueous and organic alkalis) usually have an undesirable content of metallic mercury. It is generally possible to reduce initial concentrations of mercury of up to 80 000 μg/l and above to values below 50 μg/l by means of downstream multistage process steps.

To increase the product quality and to widen the range of uses of these aqueous alkalis and the alkoxides (organic alkalis), it is desirable to remove mercury residues from the solutions by means of a simple and economical process.

The industrially most widespread process is demercurization (mercury removal) of solutions by treatment with activated carbon.

According to DE-A-26 43 478, activated carbon having a high specific surface area is suitable for demercurization, but nothing is said about the particle size of the activated carbon. DE-A-20 51 725 describes an activated carbon treatment for the liquors obtained in chloralkali electrolysis. In DE-A-34 38 098, an activated carbon which has been pretreated with mercury or with mercury salts is used in a filter bed.

A disadvantage of the use of an extremely fine powdered carbon is that even small amounts of suspended materials which may be present in the solutions to be treated considerably reduce the operating life by causing blockages.

An additional disadvantage of the known carbon filtration processes is, inter alia, the tendency of the high-surface-area activated carbons to form very fine activated carbon powders which leads to high pressure drops and poor filter performances. A further problem associated with conventional activated carbon filtrations is disposal of the mercury-laden activated carbon. In general, the activated carbon has to be treated chemically or thermally before it can be disposed of in a landfill. These additional process steps are complex or energy-intensive.

One possible demercurization method is provided by the known ability of mercury to form amalgams. For this purpose, it is possible to use, for example, a finely particulate material bearing a silver layer or a suitable metal having a very high surface area, e.g. wool, optionally used as electrode in an electrolysis cell. The removal of mercury by amalgam formation is carried out by means of a silver-coated fibre in DE-A-42 21 207 and by means of nickel wool in DE-A-25 18 433. However, such media quickly become exhausted when the mercury content of the solution is considerable over a prolonged time. They are in this case comparatively uneconomical since recovery of the expensive amalgamation metals is not always possible in industry.

Purification of wastewater polluted with mercury is also described in JP 83/128 182. Here, use is made of a tube which is provided at the top and bottom with an acid-resistant resin filter and contains from 85 to 95% by volume of activated carbon and above this from 15 to 5% by volume of carbon dust between the filters. The polluted wastewater is passed from the top downwards through the tube, with the carbon dust removing the suspended materials and the activated carbon removing the harmful substances (first and foremost mercury). For example, mercury contents of 37 mg/l are reduced to 0.0005 mg/l.

All the abovementioned processes are designed for demercurization of aqueous solutions. This can be seen from the examples: their subject matter is, in particular, the treatment of sodium hydroxide solution, sodium carbonate solutions or brines. Simple application to alkali metal alkoxide solutions is not always possible, partly because of lack of effectiveness, partly because of unsatisfactory operating lives, partly because of the use of unstable filtration auxiliaries.

DE 195 32 364 discloses a process for separating mercury from liquids, in which a mercury-containing liquid stream is allowed to flow along a surface which is structured in such a way that mercury droplets which increase in size are formed during flow.

To remove fine suspended materials and slurries, centrifuges and separators are conventionally used in industry. However, such apparatuses are susceptible to malfunction and require a high level of maintenance because of their movable parts. For this reason, a method which makes it possible to remove suspended mercury in a simple way is desirable.

It is therefore an object of the present invention to discover a simple and economically satisfactory process for removing mercury from liquids, in particular in alkali metal hydroxide solutions and also in alkali metal alkoxide solutions.

### SUMMARY OF THE INVENTION

This and other objects have been achieved by the present invention, the first embodiment of which includes a process for removal of mercury from a solution comprising mercury, the process comprising: filtering the mercury solution having a mercury feed content through at least one membrane having a pore size of 0.25 μm or less to obtain a permeate having a mercury permeate content; wherein the mercury permeate content is less than the mercury feed content.

In another embodiment, the at least one membrane having a pore size of 0.25 μm or less is a disc which is rotated about a rotational axis during the filtration.

In a special embodiment, the filtration is conducted as a dead-end filtration.

The embodiments of the present invention may further include prior to the membrane filtration, processing the feed solution with at least one operation selected from the group consisting of distillation, filtration through a fiber material different from a material of the membrane having a pore size of 0.25 μm or less and filtration through activated carbon.

### DETAILED DESCRIPTION OF THE INVENTION

The present invention provides for the use of filtration membranes having a pore size of less than or equal to 0.25 μm, preferably less than or equal to 0.1 μm and in particular less than or equal to 0.05 μm or less than or equal to 20 000 dalton retention capability, for removing mercury from mercury-containing solutions, where the mercury-containing solutions are in particular alkali metal hydroxide solutions or alkali metal alkoxide solutions.

For the purposes of the present invention, solutions are all liquids (materials in the liquid state) known to those skilled in the art, with these being able to be either homogeneous mixtures of at least two chemical substances or be pure substances.

The use of filtration membranes having a pore size of less than or equal to 0.25 μm, preferably less than or equal to 0.1 μm and in particular less than or equal to 0.05 μm, in particular from 0.005 to 0.25 μm, preferably from 0.005 to 0.1 μm and in particular from 0.005 to 0.05 μm, and very particularly preferably from 0.03 μm to 0.01 μm, is important to the invention. Such filtration membranes are referred to as ultrafiltration membranes for the purposes of the present invention.

Ultrafiltration membranes can not only be categorized according to pore size or retention capability but may also be distinguished in respect of the pore structure. According to, inter alia, the embodiments in EP 2024068, a distinction may be made between symmetrical and unsymmetrical structures. It is generally necessary to provide the ultrafiltration membranes with a support fabric or support element located on the permeate side.

The polymer used for the membrane varies depending on the field of use. Conventionally employed materials include sulphone polymers (e.g. polyether sulphone), cellulose, polyvinylidene fluoride (PVDF), polyacrylonitrile or polyacrylonitrile copolymers, polytetrafluoroethylene (PTFE) and also ceramics such as aluminium oxide.

The choice of the membrane material used may be determined by the medium to be filtered. For removal of Hg from aqueous alkalis, it is possible to use various systems, in particular, filtration membranes based on polyether sulphone, polytetrafluoroethylene (PTFE) or polyvinylidene fluoride (PVDF). The materials which can be used in alkoxide solutions is more restricted in comparison; in this case, preference is given to using membranes based on PTFE.

The present invention further provides a process for removing mercury from mercury-containing solutions by filtration, characterized in that filtration membranes having a pore size of less than or equal to 0.25 μm, preferably less than or equal to 0.1 μm and in particular less than or equal to 0.05 μm, are used. The filtration membranes may preferably be in the form of discs.

These ultrafiltration membranes may be used, in particular, in cross-flow filtrations in which only a substream is filtered (permeate) while the major part is circulated as retentate. The starting solution (feed) is pressed through filtration tubes at flow velocities of 5 m/s and above. The flow over the membrane should ensure that no blocking of the separation layer restricts permeate flow. However, owing to the flow gradients over the filtration distance, which is determined by the separation of the feed into retentate and permeate over the length of the tube, a blockage cannot always be ruled out.

Further developments in cross-flow filtration attempt to ensure flow over the membrane surface by movement of the membrane in the medium to be filtered. For this reason, the membrane is subjected to rotation. The filtration elements are in these cases used as discs and the permeate is discharged from the system via the disc interiors and the rotating hollow shaft (EP 0577854, EP 1854526). In this case, continual flow also occurs through the filter housing and the retentate is concentrated.

It has surprisingly been found that it is possible to precipitate mercury effectively from clear solutions which are completely free of suspended material or solutions which are free of turbidity-producing materials present in a different form. The turbulator-rotor filtration (TRF) described in EP 1854526 has been used for this purpose. Other ultrafiltration processes using rotating membrane discs, e.g. the single shaft disc filter (SSD filter) may in principle also be used for the demercurization of solutions.

In TRF, discs having diameters of about 100 mm are rotated about a rotational axis, with the discs having a significant spacing from the rotational axis (spacing 400 mm and above).

In an SSD filter, the significantly larger filter disc rotates about its midpoint. The advantage of the TRF process is that the flow velocity over the disc is, in comparison to the SSD filter, largely constant over the entire filter area.

In a preferred embodiment of the present invention, the filtration membranes rotate about a rotational axis. Owing to the continual rotation of the filter discs, it may be ensured that the membranes block only slowly. To circumvent comprehensive irreversible blocking of the surfaces and thus the need to change the filter, the pressure conditions at the membrane may be changed after particular time intervals. Here, a significant increase in the speed of rotation for a number of minutes while at the same time closing the inlets and outlets on the filtration vessel for in-situ cleaning of the membranes has been found to be a simple and effective process step. Even the small backflow of permeate through the membrane, which is due to the increase in the centrifugal force at the membrane surface, and the increase in the flow over the membrane ensure removal of deposits on the surface and differential pressure behaviour after recommencement of filtration which does not change over the filtration cycles. As an alternative cleaning step, it may also be possible to switch the filtration off for a number of minutes and then start it up again in the normal way. In this case, it is the compacting of the layer during the rest phase and its complete removal after start-up of the rotor which is responsible for the removal of a covering layer from the membrane. In this procedure, the inlet and outlet of the filter have to remain closed for a few minutes. This procedure likewise makes it possible to achieve the original filtration rates through the membranes.

The filtration may be conducted at speed of rotation in the range from 10 to 100 rpm, preferably from 40 to 80 rpm. In particular, the filtration is conducted at speeds of rotation of 40 rpm. After constant time intervals, inlets and outlets are closed and the speed of rotation is increased to 80 rpm for 3 minutes. The filtration process may then be recommenced immediately and the filtration is conducted as before at speeds of rotation of 40 rpm.

The viscosity of the solution and, associated therewith, the temperature at which the filtration is conducted are critical to the filtration rate. The filtration may preferably be conducted at temperatures in the range from 30° C. to 70° C., more preferably from 50° C. to 60° C. In the case of alkoxide solutions, a preferred temperature range in which the filtration rate can be optimally set is 50-60° C.

Effects of the temperatures on the separation limit or permeate quality have not been found.

The possible use of ultrafiltration membranes for removal of Hg from alkoxide solutions is limited by the chemical resistance of the membrane material to the alkoxide solution. PTFE membranes have been found to be particularly effective for the removal of Hg from alkoxide solutions. The range of materials is considerably greater for use in aqueous alkali solutions, (e.g. NaOH or KOH, 50% strength). A polyether sulphone, PVDF, etc., may also be used in addition to PTFE to ultrafilter aqueous alkali solutions.

In particular GORE SINBRAN filter discs (SD162-003) having pore sizes of 0.03 μm and which are on polyethylene support material or Gore membranes with 0.05 μm on support materials are used for demercurization of alkoxide solutions in particular embodiments of the present invention.

Owing to the high specific gravity of mercury and its ability to form colloidal atom agglomerates, the mercury structures dispersed in the solution grow during the filtration, which may be due firstly to concentration at the membrane surface and secondly may also take place as a result of an increased concentration in the retentate. Mercury droplets are ultimately formed in the solution and these collect in the lower part of the filter. To accelerate concentration in the solution, a retentate may preferably not be discharged from the filter housing, i.e. the ultrafiltration is conducted as a dead-end filtration, with inflow (feed) and filtrate outflow (permeate).

This procedure may provide some substantial advantages over conventional cross-flow processes. Firstly, the outlay in terms of apparatus and the energy usage may be significantly decreased. Mercury is concentrated directly in the filter housing, and thus leads to growth of the Hg colloid, which in turn significantly improves the ability to be separated off. A deterioration in the separation limit with concentration of the mercury in the feed solution has not been found. Finally, the mercury may be recovered directly from the filter housing via a bottom outlet and be reused.

The filtration may be operated on an industrial scale at filtration speeds (flow rate) of up to 0.25 m/h, preferably in the range from 0.1 to 0.15 m/h. The differential pressure established is, depending on the medium and temperature, in the range from 1 to 4 bar, preferably from 1.5 to 2.5 bar. The concentration of mercury in the filtrate or permeate varies in the range from 150 to 500 ppb, depending on the medium. As stated above, the initial concentrations of the solutions have no influence on the filtrate concentration and are generally in the range from 2000 to 20 000 ppb. The filtration membranes which are preferably used (SINBRAN) have been found to be extremely robust in industrial use and have achieved operating times of more than three years.

The process according to the present invention has the advantage that it is possible to dispense with the use of activated carbon or carbon-like substances as adsorbents or as auxiliary for removal of Hg, as a result of which a cost outlay for the disposal of wastes contaminated with mercury is no longer required. Mercury which has been separated off can be reused directly. Furthermore, the process can be operated with long running times since the complicated replacement of the activated carbon after saturation with mercury is dispensed with, which reduces the personnel requirement. Another substantial advantage is that a constant filtrate quality which is independent of the composition of the feed stream is ensured. Automatic backflushing cycles make it possible to keep the differential pressure behaviour and thus the filtration rate constant and the cost outlay for technical support low.

Compared to conventional cross-flow applications, a retentate stream may be dispensed with and the filtration can be used as a simple dead-end process.

The process of the invention may preferably be used for removing mercury from alkali metal hydroxide solutions or alkali metal alkoxide solutions, in particular alkali metal hydroxide solutions or alkali metal alkoxide solutions produced by decomposition of alkali metal amalgam by water or an alcohol. The preparation of alkali metal amalgam and its decomposition by water or alcohol, uncatalyzed or with use of catalysts, are conventionally known technologies. As alkali metal, use is made of lithium, sodium, potassium, rubidium or caesium, preferably sodium or potassium. Decomposition of sodium amalgam or potassium amalgam by water forms sodium hydroxide or potassium hydroxide solution. Decomposition of sodium amalgam or potassium amalgam by an alcohol forms a solution of the corresponding sodium alkoxide or potassium alkoxide in the respective alcohol. The alkalis or the alkoxide solutions are always, as described above, contaminated with mercury which may be completely or largely removed by the process of the present invention.

As alcohol for producing an alkali metal alkoxide solution to be treated according the process of the invention, it may be possible to use any desired alcohol. Preference is given to using a substituted or unsubstituted aliphatic, alicyclic, aromatic, arylaliphatic, arylalicyclic, cycloalkylaromatic or alkylaromatic alcohol. In particular, the straight-chain or branched aliphatic alcohols having from 1 to 6 carbon atoms, e.g. methanol, ethanol, 1-propanol (“n-propanol”), 2-propanol (“isopropanol”), 1-butanol (“n-butanol”), 2-butanol (“isobutanol”), 2-methyl-1-propanol (“sec-butanol”), 1,1-dimethyl-1-ethanol (“tert-butanol”) or the individual isomeric C5- or C6-alcohols, may be used. Particular preference is given to using methanol or ethanol.

Decomposition of sodium amalgam or potassium amalgam by methanol or ethanol produces a solution of sodium methoxide or potassium methoxide in methanol or a solution of sodium ethoxide or potassium ethoxide in ethanol, which may then be subjected to the process according to the present invention.

The concentration of the solution used in the process of the invention, i.e. for example of the alkali metal hydroxide solution or alkali metal alkoxide solution prepared by decomposition of alkali metal amalgam with water or alcohol may be varied within a wide range.

The process of the invention may be combined with any other conventional mercury removal process to give a total process in order to combine the removal effect of the various processes within the total process. The order in which the individual processes are conducted may be selected freely. In general, it is advantageous to carry out process steps which are suitable predominantly for the removal of relatively large amounts of mercury first and subsequently carry out fine purification processes.

The process of the invention may, for example, be combined with a process for the removal of mercury by distillation or by evaporation of the solution. Furthermore, the process of the invention may be combined with a conventionally known filtration using alternative fibre materials or activated carbon.

It is likewise possible to conduct the filtration steps a plurality of times or combine them in any way. For example, the solution concerned may be filtered a plurality of times through carbon, a plurality of times through fibre material or a plurality of times through carbon and fibre material. The filtration process of the invention may also be conducted a plurality of times and/or combined in any way and frequency with activated carbon filtration and distillation. Determination of a specific configuration and order of individual filtration steps may be based on the content of the stream to be treated, its impurity content and the removal requirements.

The process described allows a very simple removal of mercury without incurring the disadvantages of conventional carbon filtration processes. In particular, the process of the invention leads to long operating times.

Even without further information, it is assumed that a person skilled in the art can utilize the above description in its widest scope. The preferred embodiments and examples are therefore to be interpreted merely as descriptive disclosure which does not effect any limitation.

Having generally described this invention, a further understanding can be obtained by reference to certain specific examples which are provided herein for purposes of illustration only, and are not intended to be limiting unless otherwise specified.

Some examples which demonstrate the effectiveness of the process are described below. All numbers indicated are to be average values determined over the duration of the experiment.

### EXAMPLES

### Example 1

The separation limit in the separation of mercury from an aqueous 50% strength NaOH solution in a flow channel cell (filter cell MTC 55, from ETL Verfahrenstechnik) was examined.

| | | | Duration | Temperature | |
|---|---|---|---|---|---|
| Hg | Hg | Filtra- | of the | in the | Mem- |
| feed | permeate | tion | experi- | experi- | brane |
| in ppb | in ppb | rate | ment | ment | type |
| 2150 | 170 | 50 l/hm² | 5 h | 66° C. | Nadir UH |
| | | | | | 050 |

### Example 2

The separation limit in the separation of mercury from an ethanolic 14% strength sodium ethoxide solution in a flow channel cell was examined.

| | | | Duration | Temperature | |
|---|---|---|---|---|---|
| Hg | Hg | Filtra- | of the | in the | Mem- |
| feed | permeate | tion | experi- | experi- | brane |
| in ppb | in ppb | rate | ment | ment | type |
| 6110 | 122 | 228 l/hm² | 4 h | 22° C. | Gore 003 |

### Example 3

The separation limit in the separation of mercury from a methanolic 24% strength potassium methoxide solution in a flow channel cell was examined.

| | | | Duration | Temperature | |
|---|---|---|---|---|---|
| Hg | Hg | Filtra- | of the | in the | Mem- |
| feed | permeate | tion | experi- | experi- | brane |
| in ppb | in ppb | rate | ment | ment | type |
| 2450 | 491 | 558 l/hm² | 7.5 h | 21° C. | Gore 005 |

### Example 4

The separation limit in the separation of mercury from a methanolic 18% strength sodium methoxide solution in a flow channel cell was examined.

| | | | Duration | Temperature | |
|---|---|---|---|---|---|
| Hg | Hg | Filtra- | of the | in the | Mem- |
| feed | permeate | tion | experi- | experi- | brane |
| in ppb | in ppb | rate | ment | ment | type |
| 1600 | 102 | 150 l/hm² | 36 h | 22° C. | Creavis |
| | | | | | Z100S |

### Example 5

The filtration behaviour of a methanolic 18% strength sodium methoxide solution in an experimental TRF plant from FIB (NL), 3 filter discs, rotating, filter area: 0.25 m², was examined.

| | | | Duration | Temperature | |
|---|---|---|---|---|---|
| Hg | Hg | Filtra- | of the | in the | Mem- |
| feed | permeate | tion | experi- | experi- | brane |
| in ppb | in ppb | rate | ment | ment | type |
| 11 176 | 325 | 72 l/hm² | 383 h | 35° C. | Gore 005 |

### Example 6

The filtration behaviour of a methanolic 24% strength potassium methoxide solution in an experimental TRF plant from FIB (NL) was examined.

| | | | Duration | Temperature | |
|---|---|---|---|---|---|
| Hg | Hg | Filtra- | of the | in the | Mem- |
| feed | permeate | tion | experi- | experi- | brane |
| in ppb | in ppb | rate | ment | ment | type |
| 12 800 | 252 | 155 l/hm² | 46 h | 33° C. | Gore 005 |

### Example 7

The filtration behaviour of a methanolic 24% strength potassium methoxide solution in a TRF ultrafiltration plant from Minerwa (A), 27.6 m² filter area, Gore Sinbran filter discs SD162-003, 40 rpm, was examined.

| | | | Duration | Temperature | |
|---|---|---|---|---|---|
| Hg | Hg | Filtra- | of the | in the | Mem- |
| feed | permeate | tion | experi- | experi- | brane |
| in ppb | in ppb | rate | ment | ment | type |
| 9500 | 221 | 117 l/hm² | 355 days | 52° C. | Gore Sinbran |
| | | | | | filter discs |

The results of the examples show that effective removal of mercury is possible according to the present invention. Numerous modifications and variations on the present invention are possible in light of the above description. It is therefore to be understood that within the scope of the appended claims, the invention may be practiced otherwise than as specifically described.

1. A process for removal of mercury from a solution comprising mercury, the process comprising:
filtering the mercury solution having a mercury feed content through at least one membrane having a pore size of 0.25 μm or less to obtain a permeate having a mercury permeate content;
wherein
the mercury permeate content is less than the mercury feed content.

2. The process according to claim 1, wherein
the at least one membrane is a disc.

3. The process according to claim 2, wherein
during the filtration, the at least one filtration membrane disc rotates about a rotational axis.

4. The process according to claim 3, wherein a speed of rotation is from 10 to 100 rpm.

5. The process according to claim 1, wherein a temperature of the feed mercury solution is from 30° C. to 70 ° C.

6. The process according to claim 1, wherein the filtration is conducted as a dead-end filtration.

7. The process according to claim 1, wherein a filtration speed is from 0.1 to 0.15 m/h.

8. The process according to claim 1, wherein a differential pressure of the filtration is from 1 to 4 bar.

9. The process according to claim 1, further comprising prior to the membrane filtration, processing the feed solution with at least one operation selected from the group consisting of distillation, filtration through a fiber material different from a material of the membrane having a pore size of 0.25 μm or less and filtration through activated carbon.

10. The process according to claim 1, wherein the feed mercury solution is an alkali metal alkoxide and the material of the membrane is poly(tetrafluoroethylene) (PTFE).

11. The process according to claim 1, wherein the feed mercury solution is an aqueous alkali solution and the material of the membrane is selected from the group consisting of polyether sulphone, poly(tetrafluoroethylene) (PTFE) and polyvinylidene fluoride (PVDF).

12. The process according to claim 1, wherein the mercury permeate content is from 150 to 500 ppb.

13. The process according to claim 3, further comprising as an in-situ cleaning of the membrane surface:
closing inlets and outlets of a filtration vessel comprising the rotating disc membrane; and
increasing a speed of rotation of the rotating disc membrane.

14. The process according to claim 3, further comprising as an in-situ cleaning of the membrane surface:
closing inlets and outlets of a filtration vessel comprising the rotating disc membrane; and
stopping of rotation of the rotating disc membrane.
